(19) United States
(12) Patent Application Publication
(10) Pub. No.: US 2001/0003255 A1
(43) Pub. Date: Jun. 14, 2001

(54) Device for advancing a belt-saw blade

(76) Inventor: Werner Heine, Wiggensbach (DE)

Correspondence Address: NOTARO & MICHALOS P.C., Empire State Building, Suite 6902, 350 Fifth Avenue, New York, NY, 10118-6985, US

(21) Appl. No.: 09/725,696

(22) Filed: Nov. 29, 2000

(30) Foreign Application Priority Data
Dec. 10, 1999 (DE) 199 59 457 . 0

(51) Int. Cl. B27B 13/10

(52) U.S. Cl. 83/794; 83/788

(57) ABSTRACT

The invention relates to a device for the advance of a belt-saw blade by a setting width of a setting machine. In order to prevent damage on the tooth face and the cutter of belt-saw blades, the advance is effected by a roller drive, wherein the belt-saw blade is arranged with a friction fit between a roller and a counter roller and the roller drive comprises a path measurement device.

### BACKGROUND OF THE INVENTION

The invention relates to a device for advancing a belt-saw blade by a setting width of a setting machine.

With previously known setting machines, devices of the above mentioned type are generally designed such that a movable steel finger always pulls or pushes the saw on the tooth face of a tooth further by a setting width of a setting machine. One always moves to the same tooth of a setting segment, the belt-saw blade is moved further to the next setting position and the setting segment is set by the setting machine.

With a procedure of this type until now it could not be avoided that a mostly metallic contact between the finger advance and the tooth face takes place, which leads to considerable damage to the belt-saw blade and thus considerably worsens the setting result.

It is the object of the present invention to put forward a device for advancing a belt-saw blade by a setting width of a setting machine, with which damage to the tooth face and to the cutter are avoided.

This object is achieved in that the advance of the belt-saw blade is effected by a roller drive, wherein the belt-saw blade is arranged with a friction fit between a roller and a counter roller and the roller drive comprises a path measurement device. The belt-saw blade may be pulled as well as pushed through the setting machine. The roller drive provides for a very secure and quick advance of the belt-saw blade, wherein the path measurement device makes possible the advance by exactly one setting width. The enormous advantage of this device is that with this the belt-saw blade may be driven in a very gentle manner and hardly any damage to this may occur. The path measurement device may be arranged on the motor, on the drive transmission or on a roller.

A further considerable advantage is achieved in that the roller drive comprises a servo-motor. By way of this in a particularly simple manner a signal coming from a controller may be converted into a forward motion of the belt-saw blade.

According to a further embodiment form of the invention it is envisaged that the servo-motor synchronously drives the roller as well as the counter roller. This embodiment form has been ascertained to be particlarly low in slip. The belt may be accelerated and braked more quickly. Furthermore by way of this the safety is increased and the maintenance of the setting machine is less frequent.

A particularly simple design of the synchronization envisages that the servo-motor is designed to drive the roller and counter roller by way of a toothed belt with double-toothing. The toothed belt runs with its outer toothing past the toothing of the one roller and with its inner side past the toothing of the other roller and drives these synchronously.

According to a further embodiment example it is envisaged that the servo-motor via an active connection is connected to a control unit, wherein the control unit is designed to evaluate the signals of the path measuring device and to actuate the servo-motor. Apart from automatic course activation and the coordination to working courses of other machining and checking stations the control unit may advantageously also assume operations of the personnel such as drive stop, safety monitoring and likewise, and thus considerably simplify the operatability of the device.

An advantageous embodiment form of the invention envisages that the belt-saw blade in a non-toothed region is arranged with a friction fit between the roller and the counter roller. In this manner all contact of the rollers with the laterally projecting teeth of the belt-saw blade is avoided, by which means the service life of the rollers is lengthened and the quality of the setting result may be improved.

A particularly constant friction fit force for the drive of the belt-saw blade is achieved in that one of the rollers is fixed on the housing of the roller drive and the other roller is rotatably fastened on a pivoting arm. The pivoting arm is fastened on the housing by way of a joint, wherein a pneumatic pressing means acting on the pivoting arm produces the pressing pressure for the friction fit of the belt-saw blade. Even with various thicknesses of the belt-saw blade or temporary deviations in the thickness there is ensured a low-slip advance of the belt-saw blade.

In a further advantageous embodiment form of the invention it is envisaged that the advance device comprises an photo-detector, preferably a laser photo-detector for the exact recording of the advance of the belt-saw blade. By way of contamination or occurences of wear the actual advance may deviate from that which is set. Such deviations may be recognized and compensated with the help of the mentioned embodiment form with an optical recording of the saw teeth. A coarse positioning is effected by the path measuring device, the exact positioning however by way of the photo-detector which measures the advance of the belt-saw blade on account of the saw teeth which have travelled past, and by way of the effect on the servo-motor effects an exact positioning of the belt-saw blade.

It is particularly advantageous to design the device such that the photo-detector is connected via an active connection to a control unit, and the control unit is designed to evaluate signals of the photo-detector. The coarse positioning and the fine positioning may be very quickly and securely carried out by the control unit. This contributes to the increase of the safety against breakdown and to the low-maintenance.

According to a further advantageous embodiment form the photo-detector is arranged on a start means which is displaceable on the housing in the advance direction, preferably on a rail, and is fixably arranged, and comprises a foldable finger for setting the relative position of the photo-detector to the belt-saw blade. After aligning the belt-saw blade to the setting position in the setting machine it is necessary for the photo-detector to be exactly set to the saw tooth to be activated in each case. With the help of the start means according to the invention the positioning may be carried out in a particularly advantageous manner in that the operating person sets the finger to the saw tooth to be activated, fixes the start means and then again folds away the finger. Thereafter the photo-detector is then set to the correct tooth and the setting process may be started.

### BRIEF DESCRIPTION OF THE DRAWINGS

In the following, one embodiment example of the invention is explained in more detail by way of the drawings.

There are shown in

FIG. 1: a device according to the invention in a plan view,

FIG. 2: a lateral view of the start means according to line A-A.

### DETAILED DESCRIPTION OF THE INVENTION

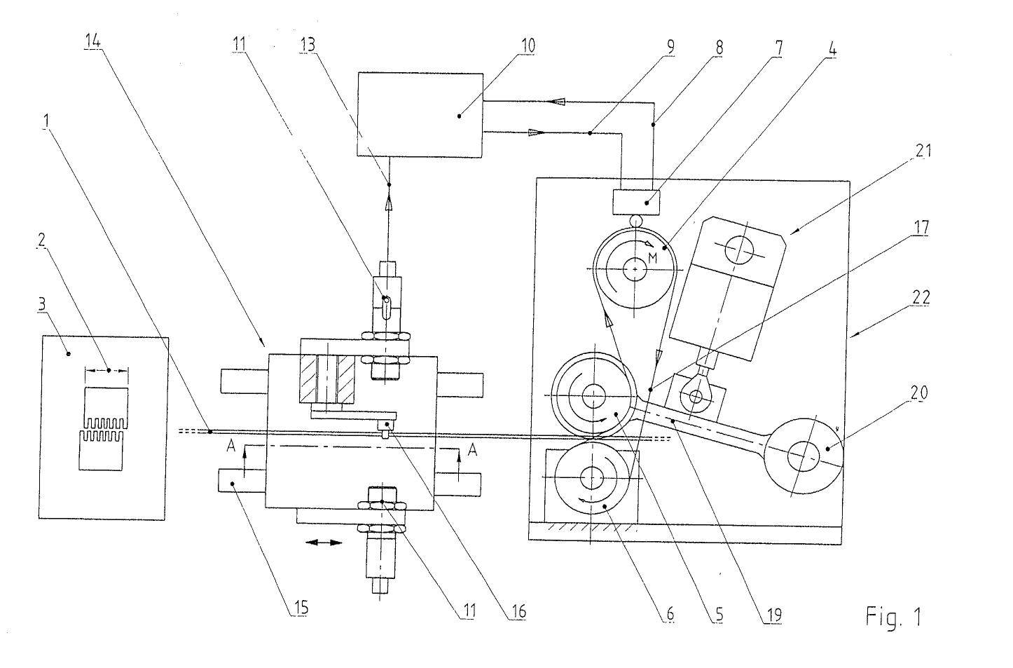

From FIG. 1 it is deduced that the belt-saw blade 1 is led through the whole device, wherein a roller drive 22 provides for the advance of the belt-saw blade 1 by a setting width 2 of a setting machine 3.

The roller drive 22 consists of a servo-motor 4 which is provided with a path measuring device 7. The path measuring device 7 may however also be arranged in the servo-motor itself. The servo-motor 4 via a double-toothed belt 17 synchronously drives a roller 5 and a counter roller 6. A toothed belt 17 runs with its inner side around a toothing of the driving servo-motor 4 and a toothing of the counter roller 6; with its outer side and thus in the opposite direction it drives a toothing of the roller 5.

The counter roller 6 is in this embodiment example rigidly attached on the housing of the roller drive 22. The roller 5 in contrast is fastened on a pivoting arm 19 which via a joint 20 is fastened on the housing of the roller drive 22. The rotational axes of the roller 5, of the counter roller and of the joint are arranged parallel to one another.

By way of a pneumatic pressing means 21 the pivoting arm 19 and thus the roller 5 is pressed in the direction of the counter roller 6. By way of this the force for the friction fit of the belt-saw blade 1 between the two rollers 5 and 6 is produced.

A central control unit 10 via an active connection 8 receives signals from the path measuring device 7 and by way of an active connection 13 from an photo-detector 11. These signals via an active connection 9 are conveyed to the servo-motor and by this are converted into an advance movement.

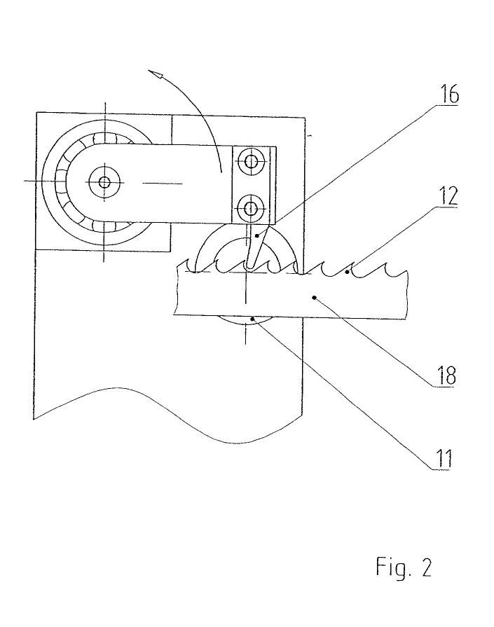

The photo-detector 11 is arranged on a start means 14 which for setting the correct start position is displaceably and fixably attached on the rails 15. The photo-detector 11 is arranged orthoganally to the belt-saw blade 1 and records the saw teeth 12 which are shown in FIG. 2.

Likewise on the start means 14 there is arranged a foldable finger 16 which in FIG. 2 is to be seen in a lateral view. Before the start of the setting procedure the start means 14 must be exactly positioned so that the photo-detector is calibrated onto the correct saw tooth. For this purpose the foldable finger 16 is brought into abutment exactly in the tooth face of the corresponding saw tooth, subsequently the start means 14 is fixed and the finger 16 is again folded out so that the belt-saw blade 1 may be displaced. The photo-detector is arranged exactly flush with the foldable finger 16. By way of the setting procedure before the start it is exactly positioned onto the corresponding tooth of the belt-saw blade 1. This procedure is thus only necessary at the beginning of the setting procedure and must then only be carried out again on applying a new belt-saw blade 1.

The belt-saw blade 1 for taking care of the saw teeth 12 is driven by the two rollers 5 and 6 only in the non-toothed region 18.

### LIST OF REFERENCE NUMERALS

1: belt-saw blade

2: setting width

3: setting machine

4: servo-motor

5: roller

6: counter roller

7: path measuring device

8: active connection

9: active connection

10: control unit

11: photo-detector

12: saw tooth

13: active connection

14: start means

15: rail

16: foldable finger

17: toothed belt

18: non-toothed region

19: pivoting arm

20: joint

21: pressing means

22: roller drive

1. A device for advancing a belt-saw blade by a setting width of a setting machine, wherein the advance of the belt-saw blade is effected by a roller drive, wherein the belt-saw blade is arranged with a friction fit between a roller and a counter roller and the roller drive comprises a path measurement device.

2. A device according to claim 1, wherein the roller drive comprises a servo-motor.

3. A device according to claim 2, wherein the servo-motor synchronously drives the roller as well as the counter roller.

4. A device according to claim 2 or 3, wherein the servo-motor is designed to drive the roller and the counter roller by way of a toothed belt with double toothing.

5. A device according to one of the claims 2 to 4, wherein the servo-motor via an active connection is connected to a control unit and wherein the control unit is designed to evaluate signals of the path measuring device and to actuate the servo-motor.

6. A device according to one of the preceding claims, wherein the belt-saw blade in a non-toothed region is arranged between the roller and the counter roller with a friction fit.

7. A device according to one of the preceding claims, wherein one of the rollers is fixed on the housing of the roller drive and the other roller is rotatably attached on a pivoting arm, wherein the pivoting arm is fastened on the housing by way of a joint, and a pneumatic pressing means acting on the pivoting arm is designed to produce the pressing pressure for the friction fit of the belt-saw blade.

8. A device according to one of the preceding claims, wherein the advance device comprises an photo-detector, preferably a laser photo-detector for the exact recording of the advance of the belt-saw blade.

9. A device according to claim 8, wherein the photo-detector is connected via an active connection to a control unit, and the control unit is designed to evaluate signals of the photo-detector.

10. A device according to claim 8 or 9, wherein the photo-detector is arranged on a start means which is displaceable on the housing in the advance direction, preferably on a rail, and is fixably arranged, and comprises a foldable finger for setting the relative position of the photo-detector to the belt-saw blade.
